(19) United States
(12) Patent Application Publication
(10) Pub. No.: US 2005/0067432 A1
(43) Pub. Date: Mar. 31, 2005

(54) Pocket and packaging device including a pocket

(75) Inventor: Philippe Bonneyrat, Herblay (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/926,079

(22) Filed: Aug. 26, 2004

Related U.S. Application Data
(60) Provisional application No. 60/502,963, filed on Sep. 16, 2003.

(30) Foreign Application Priority Data
Aug. 29, 2003 (FR) 03 10325

(51) Int. Cl. B67D 5/40

(52) U.S. Cl. 222/105; 222/383.1

(57) ABSTRACT

A packaging device for a product, particularly a cosmetic product. The device includes a bottle and an internal pocket disposed inside the bottle and capable of containing the product. The pocket is freely deformable inside the bottle. In addition, in a preferred form, the pocket is formed by an extrusion blow molding process, and includes either: i) at least two layers made of the same material; or ii) at least first and second layers made of at least two different physically and chemically compatible materials, with the first layer in contact with the product, and the second layer in contact with a space defined between the pocket and an internal wall of the bottle. By way of example, the bottle can be made of polyethylene and the internal pocket can include two bonded layers of polyamide. The device better ensures the absence of micro-holes in the internal pocket.

### CROSS REFERENCE TO RELATED APPLICATIONS

This document claims priority to French Application Number 03 10325, filed Aug. 29, 2003 and U.S. Provisional Application No. 60/502,963, filed Sep. 16, 2003, the entire contents of which are hereby incorporated by reference.

### FIELD OF THE INVENTION

The present invention relates to a packaging device in a composite plastic material with enhanced leaktightness characteristics. The invention can be particularly advantageous for use in the field of packaging devices for sensitive cosmetic products ranging in consistency from liquid to paste, such as coloring and/or decoloring oxidants, skincare creams, or sun creams, which should or must only come into contact with the air at the time of use.

### BACKGROUND OF THE INVENTION

1. Discussion of Background

Certain cosmetic products are sensitive to air such that contact with air either should or must be prevented until use is desired. For example, contact with the air can generate reduction reactions which degrade the cosmetic products, thereby rendering them ineffective at the time of use. To dispense such sensitive cosmetic products in optimal conditions, use is generally made of devices or assemblies including a bottle, inside of which is disposed a deformable internal pocket, with the product being stored inside the pocket. Preferably, these devices are then equipped with airless means of dispensing the product. There is therefore a need to provide internal pockets that are both flexible and leaktight. In order to impart a degree of flexibility to these pockets, which are usually made of plastic, they are generally of a thin-walled construction.

For example, document WO 93/22,220 describes a known product dispenser having a deformable pocket, with the pocket being inserted into the bottle, and with the pocket being preformed by welding the edges of a lengthwise strip onto itself. As the internal pocket is made separately from the bottle before insertion into the bottle, its leaktightness can be tested before it is placed in the bottle. However, this arrangement has the drawback of being time-consuming and awkward to put into practice.

With such bottles, in which the internal pocket is fitted after it is formed, pockets may be provided in which the wall is formed by a complex structure having at least three layers. The complex structure then forms a stratified and laminated material including a first impermeable layer made of a first material, for example polyethylene, and a second impermeable layer made of a second material, for example polyamide, distinct from the first material. The two layers are then bonded to one another by means of a third uniform and intermediate binder or adhesive layer to facilitate adhesion between the first two layers. This complex structure is then cut into the shape of panels, with the panels then being assembled together to form the pocket.

At the present time, the majority of packaging devices such as tubes or bottles, used in the field of cosmetics, are made of thermoplastic material. Polyolefins are generally used, with these materials being recyclable and non-polluting. Generally speaking, polyolefin packaging is made by extrusion, for example by extrusion blow molding, as taught in document U.S. Pat. No. 4,179,251.

A coextrusion blow molding process known in the current state of the art is used to obtain a bottle and its internal pocket simultaneously, notably as described in document EP 0,182,094. According to this document, the bottle is made of PVC and the internal pocket is made of polyethylene.

Polyolefins have good gas and water vapor impermeability properties and have the advantage of being compatible with most chemical products. However, the polyolefin packaging devices obtained may present the drawback of having micro-holes. The term micro-hole is understood to mean a hole such that the impermeability of a surface in which it occurs is no longer assured locally and relative to the overall impermeability of the surface. In effect, when the packaging devices are made by extrusion blow molding, micro-holes occur due to the presence of impurities in the plastic material during processing. The thinner the walls, the greater the likelihood that these micro-holes will occur.

In order to overcome leakage problems, in a manner known in the current art, the wall thickness is increased. However, this approach is to the detriment of the flexibility of the internal pocket thus formed.

### SUMMARY OF THE INVENTION

A preferred approach according to the invention allows a device to be manufactured with a process that is simple, easy to implement, and inexpensive, preferably by applying the same manufacturing process to form the bottle and the internal pocket of the device.

While use of the same manufacturing process serves to simplify the manufacturing operations, it can make the performance of production quality inspection tests more complicated. In effect, given that the internal pocket is already inside the bottle as it leaves the assembly machine, it is difficult or impossible to test the bottle and pocket separately without losing the benefit of having made these two elements in the same process.

A leaktightness test for a pocket involves placing the cavity formed by the pocket under excess pressure and then, after a given period of time has elapsed, measuring the pressure variation inside the pocket. If no decrease in the internal pressure of the pocket is observed, the pocket is considered to be leak free. The problem associated with the performance of this type of test is that such tests are not an effective means of detecting leaks. In effect, when the internal pocket of a bottle is placed under excess pressure, it can adhere in a leaktight manner against the inner surface of the bottle inside which it has been made. Thus, if a micro-hole in this pocket is pressed locally against the inner surface of the bottle during the test, the inner surface of the bottle will block off the micro-hole and the micro-hole will not be detected. If such leaktightness tests are performed on internal pockets in situ, the reliability of the tests is very low.

The invention provides a packaging device in which the bottle and the internal pocket can be obtained by the same process, and such that the requirement to test the leaktightness of the internal pocket is avoided by choosing a structure for this inner layer that better ensures the absence of micro-holes.

Preferably, the process used to obtain the pocket and the bottle is extrusion blow molding. Since the pocket is flexible, to facilitate retraction of the pocket on itself inside the bottle, there should be no adhesion between the inner wall of the bottle and the outer wall of the pocket during the manufacturing process. To this end, the bottle is made with a first material, and the internal pocket is made with a second material. The first material is incompatible with the second material such that, during cooling of these materials, the internal pocket does not adhere to the bottle.

According to one preferred aspect, an innovative structural feature of the pocket is provided by a pocket whose wall includes at least two layers attached together, without the use of a binder or adhesive, so that it remains simple while at the same time ensuring the absence of micro-holes.

In effect, if one or both layers have one or more micro-holes, by virtue of the extrusion manufacturing process, the probability that a hole in the first layer will be located directly opposite a hole in the second layer is very small, virtually nil in accordance with a preferred form. The double-thickness pocket thus obtained, from one or more materials in the same class of chemicals, does not therefore have any through holes. This assurance means that the risk of leakage of finished products is reduced or eliminated. Furthermore, this assurance facilitates the performance of leaktightness tests, in that only large leaks need to be detected. Tests for the detection of micro-leaks, which are difficult to implement during a production cycle, can be eliminated, thereby improving the overall process of coextrusion of the pocket in the bottle.

In accordance with one object of the invention, a packaging device for a product, particularly a cosmetic product, is provided which includes a bottle and an internal pocket disposed inside the bottle which is capable of containing the product. The pocket is freely deformable inside the bottle and, in accordance with a preferred form, the internal pocket includes one of:
(i) at least two layers (6, 7) made of the same material and attached to each other by direct physicochemical reaction between the materials of said at least two layers; and
(ii) first and second layers (6, 7) made of at least two different materials physically and chemically compatible with each other, with the first layer (6) being in contact with the product, the second layer (7) defining the outer wall of the pocket, and with the first and second layers being attached to each other by direct physicochemical reaction between the material of the first layer and the material of the second layer.

As used above and herein, the internal pocket “including one of,” is to be understood as encompassing arrangements including either (i) or (ii), and also encompassing arrangements including (i) and (ii). In other words, the pocket could include one of the features or potentially both features.

In the invention, the expression physically and chemically compatible materials is understood to mean materials which, when placed in contact with each other in the molten state, are capable of creating physicochemical bonds producing mutual adhesion of the two materials. Thus, mutual cohesion or adhesion of the layers is assured de facto, and the integrity of the pocket is thus better ensured.

The expression direct physicochemical reaction is understood to mean that the reaction which takes place between the materials, under given temperature and pressure conditions, facilitates mutual attachment and adhesion of the layers, the layers being respectively formed from each of these materials. Direct physicochemical reactions exclude reactions requiring the application of a binder between the materials. In particular, the physicochemical reactions take place at temperatures close to the melting points of the different materials. This effectively means that a process of thermo-welding or thermo-fusion takes place between the materials of the different layers.

When the reaction is complete, the assemblage of layers is brought to ambient temperature, i.e., around 25° C., at which point it can be seen that the layers thus assembled are integral with each other.

Preferably, the internal pocket only includes layers made of the same material which are directly attached to each other.

Advantageously, at least 80% of the mass of each of the two layers is comprised of the same compound or several compounds belonging to the same chemical family. Preferably, in all cases the compound(s) chosen for each of these layers all belong to the same chemical family. The term “chemical family” is understood to mean a group of molecules characterized by the presence of a particular chemical function in each of the molecules in the group. In this case, and by the fact that the first layer is made from a compound in the same chemical family as that of the compound used to form the second layer, the two layers are physically and chemically compatible with each other and preferably adhere perfectly to each other. They remain welded to each other to form the wall of the internal pocket, after cooling.

Even more advantageously, the chemical family is preferably chosen from the following chemical families of thermoplastic polymers: the family of polyolefins, the family of polyvinyl chlorides and derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

In a preferred embodiment, the two coextruded layers of the internal pocket are made with the same compound, representing over 80% of their mass. This same compound belongs to the family of polyamides, for example, and in this case, preferably polyamide 11.

As a variant, the two coextruded layers of the internal pocket can each be made from two different compounds but from the same chemical family. For example, a first layer of this internal pocket can include at least 80% of a compound belonging to the polyamide family, for example polyamide 6,6, while a second layer of this internal pocket can include at least 80% of another compound belonging to the polyamide family, for example, polyamide 11.

In accordance with a particular example, one of the layers forming the internal pocket includes a filler, which may or may not be colored, and which is designed to impart color or to render opaque the layer of the internal pocket. This modification of the appearance of one of the layers serves as a means of detecting the presence of the internal pocket in the bottle. If the pocket is colored, it is easier to detect by means of cameras installed on the production line, for example, with analysis of the images in real time on the production line. As a variant, additives or other molecules with antistatic properties for example, can be incorporated into the formulation of the layers. Additives can account for up to 20% by weight of the composition of each of the layers of the internal pocket.

A further advantage to placing the colored filler or any other type of additive in only one of the layers of the pocket is that it provides a saving on the quantity of colorant or additive to be used.

Preferably, the colored filler and/or the additives are incorporated into the formulation of the internal layer of the pocket, and this layer does not come into contact with the inner wall of the bottle. The internal layer could possibly come into contact with the product to be stored. Furthermore, this arrangement makes it possible to avoid interference with the inner wall of the bottle, and notably avoids unwanted adhesion effects attributable solely to the presence of these additives or colorants.

By way of example, the layers of the pocket are coextruded. Preferably, the internal pocket is obtained by an extrusion blow molding process. Advantageously, the internal pocket and the bottle are preferably coextruded simultaneously by the same extrusion blow molding process.

Further, by way of example, the bottle can also be made of a material including at least one compound belonging to one of the chemical families of thermoplastic polymers cited above. In this case, it is made from one or more compounds belonging to chemical families different from that chosen to provide more than 80% by weight of the compound(s) forming the internal pocket.

Advantageously, the bottle is made from of a material having low adherence with the outer layer of the internal pocket, particularly during the extrusion blow molding process, to better ensure non-adherence between the outer layer of the internal pocket and the inner wall of the bottle. For example, the bottle can be made using a compound chosen from the polyolefins family, and the pocket is then made from one or more compounds chosen from the polyamides family. More particularly, the bottle can be made of high density polyethylene, and at least one of the layers of the internal pocket with at least 80% by weight of polyamide 11.

Preferably, the wall of the internal pocket has a thickness between 1/10th and 3/10th of a millimeter. The layers can be of equal thickness or of different thickness, and in the latter case the outer layer is generally thicker than the inner layer.

Advantageously, the internal pocket preferably presents an opening arranged so that it is circumscribed within the opening of the bottle. The product can be introduced into and removed from the device via these openings, with the product stored in the internal pocket.

In a preferred embodiment of the invention, the device is equipped with a dispensing means, for example of the type referred to as the airless pump. These airless pumps are widely used, notably in the field of cosmetics, for dispensing beauty care products in the form of a single phase, generally liquid. The invention can be particularly advantageous for body lotions, moisturizers or sunscreen products. Such dispensers are particularly advantageous in that they enable the product to be kept isolated from the air. By reason of their instability in the presence of air, hair coloring and/or decoloring products can be advantageously dispensed by such airless pump systems. The pump can be of the piston type, diaphragm type or valve type. Such pumps are well known, and therefore do not require further detailed description.

Whenever such an airless pump is activated, the volume of the pocket mounted in the bottle diminishes by an amount corresponding to the volume of the quantity dispensed, so that, throughout the lifetime of the device, the product occupies substantially the entire available volume of the internal pocket. To this end, the bottle incorporates an air intake aperture so that the outer surface of the internal pocket is always subject to ambient pressure.

Alternatively, the device is simply fitted with a cap to close off the apertures in the internal pocket and the bottle in a leaktight and sealed manner. In particular, in the case where the dispensing means is fitted to the apertures only before the device is used, and after having placed other formulations inside the bottle and/or the internal pocket, a cap is then provided for the storage phase of the device.

Advantageously, the device is designed to be particularly advantageous to hold a skin care and/or hair care type product.

A further object of the invention is to provide a flexible pocket capable of holding a product such as a cosmetic product, in which the pocket includes one of:
(i) at least two layers (6, 7) made of the same material and attached to each other by direct physicochemical reaction between the materials of said at least two layers; and
(ii) first and second layers (6, 7) made of at least two different materials physically and chemically compatible with each other, with the first layer (6) being in contact with the product, the second layer (7) defining the outer wall of the pocket, and with the first and second layers being attached to each other by direct physicochemical reaction between the material of the first layer and the material of the second layer.

As noted earlier, the arrangement could include either of the above features (i) and (ii), or both, as is to be understood from the use of “includes one of” herein.

Preferably, the flexible pocket only includes layers made of the same material and directly attached to each other.

Advantageously, the at least two layers are adjacent, such that each of the two layers each contains at least 80% by weight of the same compound or several compounds belonging to the same chemical family, with the compound(s) preferably chosen for these at least two layers belonging to the same chemical family.

Even more advantageously, the chemical family is preferably chosen from the following chemical families of thermoplastic polymers: the family of polyolefins, the family of polyvinyl chlorides and their derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

Even more advantageously, the two layers are made from the same compound, for example belonging to the family of polyamides, in particular, for example, polyamide 11.

Preferably, a first layer of the pocket is made from a compound belonging to the polyamides family, for example polyamide 6,6, and a second layer of the pocket is made from a different compound belonging to the same polyamides family, for example polyamide 11.

For example, one of the layers forming the internal pocket can include a filler, which may or may not be colored, designed to impart color or to render opaque the layer of the flexible pocket.

Advantageously, the flexible pocket forms a wall having a thickness between 1/10th and 3/10th of a millimeter, which can ensure its flexibility.

Preferably, the pocket is obtained by an extrusion blow molding process.

Alternatively, another object of the invention is to provide a packaging device for a product, notably a cosmetic product, which includes a bottle and an internal pocket disposed inside the bottle and which is capable of containing the product. The internal pocket is freely deformable inside the bottle. In addition, the internal pocket includes several layers made from different materials that are physically and chemically compatible with each other such that each of the layers is capable of being attached to any other layer of the pocket by direct physicochemical reaction between the materials respectively constituting each of these layers.

In another variant, another object of the invention is to provide a packaging device for a product, particularly a cosmetic product, which includes a bottle and an internal pocket disposed inside the bottle which is capable of containing the product. The pocket is freely deformable inside the bottle. In addition, the internal pocket includes at least first and second layers, with the first layer being made of a first material different from a second material constituting the second layer. Further, the first and second materials are non-adhesive and physically and chemically compatible with each other such that the first and second layers are attached to each other by direct physicochemical reaction between the material of the first layer and the material of the second layer.

A material is considered to be adhesive when it is capable of providing a bond between two physically and chemically incompatible materials, by virtue of their polar or apolar nature, or by virtue of the absence in each material of groups capable of creating chemical bonds between them.

### BRIEF DESCRIPTION OF THE DRAWINGS

The invention will become further apparent from the following detailed description, particularly when considered in conjunction with the drawings in which:

FIG. 1 illustrates a first embodiment of a device according to the invention; and

FIG. 2 illustrates a second embodiment of a device according to the invention.

### DETAILED DESCRIPTION OF THE PREFERRED EMBODIMENTS

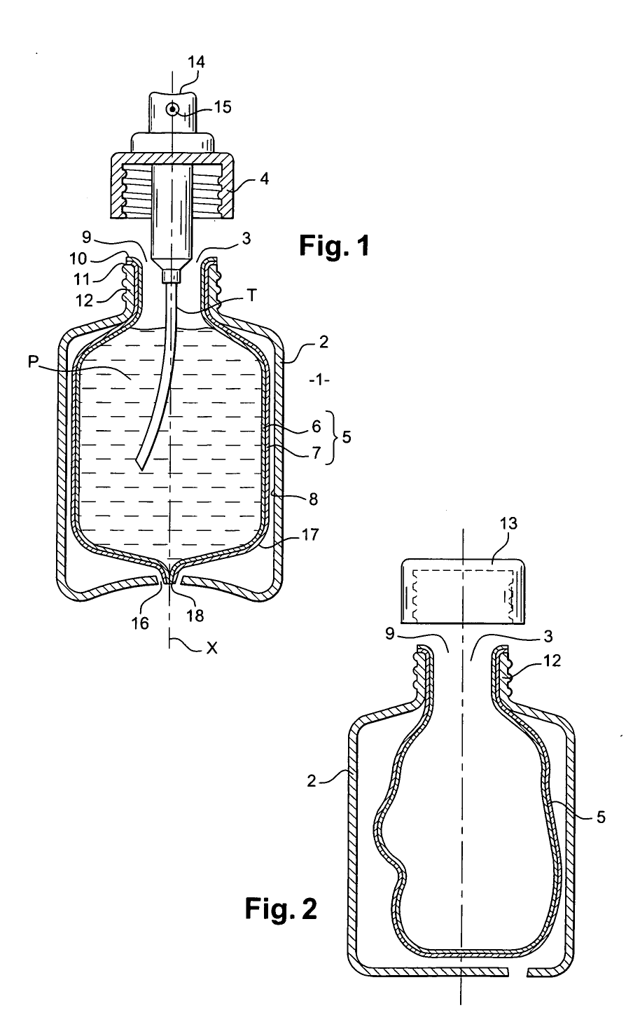

FIG. 1 illustrates a device 1 according to the invention. The device 1 includes, by way of example, a substantially cylindrical bottle 2 having an axis X. The bottle 2 is made, for example, of polyethylene. The bottle 2 incorporates an opening 3 orthogonal to the axis X. The bottle 2 is surmounted by a dispensing means 4 for a product P contained in an internal pocket 5 disposed inside the bottle 2.

The internal pocket 5 has flexible and deformable walls. As shown, the pocket includes a first inner layer 6 in contact with the product, and a second outer layer 7 which is capable of being placed in contact with the inner wall 8 of the bottle 2. The inner layer 6 and outer layer 7 are made of the same material in this example, for example polyamide.

The two layers 6 and 7 are perfectly attached despite the fact that they are formed as a double layer. The existence of a joint plane between these two layers can be invisible to the naked eye due to the fact that they are each formed simultaneously using the same material and without a binding agent being interposed between these layers. In the case where one of the layers incorporates a colored filler, the joint plane is visible when viewed in transverse cross-section on the wall of the pocket. Alternatively, the joint plane can also be detected using a microscope during analysis of a transverse cross-sectional plane of the wall.

As a variant, the pocket 5 can be made by attaching a plurality of layers of the same material. For example, as a variant, the pocket 5 can include three layers, two of these being made of an identical material, so that an intermediate layer disposed between these two identical layers is made with a physicochemically compatible material capable of reacting directly with these two layers. For example, the pocket 5 can include two layers of polyamide 6,6 between which is interposed a layer of polyamide 11. As a further variant, the pocket 5 can include a first layer made of low density polyethylene which is bonded by direct physicochemical reaction to a layer of high density polyethylene which in turn is bonded by direct physicochemical reaction to a layer of polypropylene. In this structure, the low density polyethylene chosen may also be capable of direct physicochemical reaction with the polypropylene. In this structure, the different layers are each physically and chemically compatible, two by two, respectively with the other layers.

An aperture 9 in the pocket 5 is circumscribed within the opening 3 of the bottle 2. For example, the pocket 5 incorporates an edge 10 folded back on a circumference 11 of the aperture 3. The bottle 2 preferably includes a neck 12 delineating the aperture 3. As depicted in FIG. 1, the neck 12 is threaded to hold the dispensing means 4. Alternatively, as shown in FIG. 2, the neck 12 is also threaded to receive a cap 13 capable of closing off the aperture 3 in the bottle 2 and the aperture 9 in the pocket 5 in a leaktight manner.

In the example illustrated in FIG. 1, the dispensing means 4 is a pump having an actuating surface 14 extending, for example, substantially perpendicular to the axis X. A nozzle 15 on the pump directs a jet of product, preferably on a trajectory orthogonal to the axis X. In particular, preferably an airless pump is mounted on the device 1. In this case, whenever a quantity of product P is dispensed, the internal volume of the internal pocket 5 diminishes by a volume equal to that of the quantity dispensed. To facilitate such a retraction of the pocket 5 on itself, the bottle 2 incorporates an air intake aperture 16. Via this aperture 16, the outer surface 17 of the internal pocket 5 is subjected to atmospheric pressure, and the internal pocket 5 can thus be progressively discharged through the pump 4 without taking in air.

It is to be understood that other types of dispensing means can be used within the scope of the present invention.

By way of example, the dispensing means 4 can include an immersion tube T, depending on the mode of filling, with the product P maintained under vacuum or otherwise in the internal pocket 5.

In the example illustrated in FIG. 1, the pump 4 is screwed on, but it can alternatively be clamped, crimped or force fitted.

For example, when the product P contained in the pocket 5 first needs to be mixed with another formulation before being dispensed, the device 1 can be initially closed off by the cap 13, and after the mixture has been formed a dispensing means such as 4 is mounted on the neck 12. In this case, the pump supplied separately from the device 1 is designed, for example, to be screwed onto the neck 12 in place of the cap 13 initially closing off the bottle 2.

In the example illustrated in FIG. 1, the pocket 5 is also closed at the level of a weld joint 18. An opening in the bottle or outer container is maintained at this level, with the materials of the bottle 2 and the pocket 5 being incompatible, such that the opening can for example perform the role of air intake aperture 16.

Of course, the invention is not limited to the examples described above, and the features of the different embodiments and examples may be variously combined.

Throughout the description, including the claims, expressions such as “including two” or “comprising two” should be understood to be synonymous with “including at least two” unless otherwise specified.

Obviously, numerous modifications and variations of the present invention are possible in light of the above teachings. It is therefore to be understood that, within the scope of the appended claims, the invention may be practiced otherwise than as specifically described herein.

1. A packaging device for a product including:
a bottle; and
an internal pocket disposed inside the bottle and capable of containing the product, wherein the pocket is freely deformable inside the bottle, and wherein the internal pocket includes one of:
(i) at least two layers which are made of the same material and which are attached to each other by direct physicochemical reaction between the materials of said at least two layers; and
(ii) first and second layers made of at least two different materials which are physically and chemically compatible with each other, wherein the first layer is in contact with the product, and the second layer is in contact with a space defined between the pocket and an inner wall of the bottle, and wherein the first and second layers are attached to each other by direct physicochemical reaction between the material of the first layer and the material of the second layer.

2. A device according to claim 1, wherein the internal pocket includes only layers made of the same material which are directly attached to each other.

3. A device according to claim 2, wherein each of the layers each contains at least 80% by weight of the same compound or plural compounds belonging to the same chemical family, and wherein the compound(s) chosen for these layers belong to the same chemical family.

4. A device according to claim 3, wherein the chemical family is chosen from one of the following chemical families: the family of polyolefins, the family of polyvinyl chlorides and derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

5. A device according to claim 1, wherein each of the layers each contains at least 80% by weight of the same compound or plural compounds belonging to the same chemical family, and wherein the compound(s) chosen for these layers belong to the same chemical family.

6. A device according to claim 5, wherein the chemical family is chosen from one of the following chemical families: the family of polyolefins, the family of polyvinyl chlorides and derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

7. A device according to claim 6, wherein each of the layers are made of a compound belonging to the polyamide family.

8. A device according to claim 7, wherein the layers include polyamide 11.

9. A device according to claim 1, wherein two layers are made of the same compound.

10. A device according to claim 9, wherein the compound belongs to the polyamides family.

11. A device according to claim 10, wherein the compound includes polyamide 11.

12. A device according to claim 1, wherein the pocket includes said first and second layers made of at least two different materials, and wherein the first layer of the pocket is made from a compound belonging to the polyamides family, and the second layer of said pocket is made from a different compound belonging to the same polyamides family.

13. A device according to claim 12, wherein the first layer includes polyamide 11 and the second layer includes polyamide 6,6.

14. A device according to claim 1, wherein one of the layers forming the internal pocket includes a filler which imparts color to said layer of the internal pocket, thereby forming a means of detecting the presence of the internal pocket in the bottle.

15. A device according to claim 14, wherein the layer of the internal pocket which includes said filler is an inner layer.

16. A device according to claim 1, wherein one of the layers includes a filler which renders said layer opaque, thereby forming a means of detecting the presence of the internal pocket in the bottle.

17. A device according to claim 16, wherein the layer of the internal pocket which includes said filler is an inner layer.

18. A device according to claim 1, wherein the layers of the internal pocket are coextruded.

19. A device according to claim 1, wherein the internal pocket is formed by extrusion blow molding.

20. A device according to claim 1, wherein the internal pocket and the bottle are coextruded.

21. A device according to claim 1, wherein the bottle is made of a material having a low adherence with the outer layer of the internal pocket to ensure non-adherence between the outer layer of the internal pocket and the inner wall of the bottle.

22. A device according to claim 21, wherein the material of the bottle has a low adherence during an extrusion blow molding process.

23. A device according to claim 1, wherein the bottle is made from a compound chosen from the polyolefins family, and the pocket is made from one or more compounds chosen from the polyamides family.

24. A device according to claim 1, wherein the internal pocket forms a wall having a thickness between one-tenth and three-tenths of a millimeter.

25. A device according to any claim 1, wherein an aperture in the pocket is circumscribed within an opening in the bottle.

26. A device according to claim 1, further including a dispensing means for the product contained in the pocket.

27. A device according to claim 26, wherein the dispensing means includes an airless pump.

28. A device according to claim 27, further including a cap to close off an aperture in the pocket.

29. A device according to claim 1, further including a cap to close off an aperture in the pocket.

30. A device according to claim 1, further including a product disposed in said internal pocket, and wherein said product is a cosmetic product.

31. A device according to claim 30, wherein said product is a skincare product.

32. A device according to claim 30, wherein said product is a haircare product.

33. A device according to claim 1, wherein each of the layers each contains at least 80% by weight of the same compound.

34. A device according to claim 33, wherein each compound forming one of the layers belongs to the same chemical family as each compound forming another of the layers.

35. A device according to claim 1, wherein each compound forming one of the layers belongs to the same chemical family as each compound forming another of the layers.

36. A device according to claim 35, wherein each layer is formed of plural compounds.

37. A device according to claim 1, wherein at least 80% by weight of a material forming the first layer is of the same compound or compounds as a material forming the second layer.

38. A flexible pocket for containing a product, wherein the pocket includes at least one of:
(i) at least two layers which are made of the same material and which are attached to each other by direct physicochemical reaction between the materials of said at least two layers; and
(ii) first and second layers made of at least two different materials which are physically and chemically compatible with each other, wherein the first layer is in contact with the product, and wherein the second layer defines an outer wall of the pocket, and further wherein the first and second layers are attached to each other by direct physicochemical reaction between the material of the first layer and the material of the second layer.

39. A pocket according to claim 38, wherein the pocket only includes layers made of the same material which are directly attached to each other.

40. A pocket according to claim 38, wherein the pocket includes at least two adjacent layers, each of the two layers each containing at least 80% by weight of the same compound or several compounds belonging to the same chemical family, the compound(s) chosen for these at least two layers belonging to the same chemical family.

41. A pocket according to claim 40, wherein the chemical family is chosen from one of the following chemical families of thermoplastic polymers: the family of polyolefins, the family of polyvinyl chlorides and derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

42. A pocket according to claim 38, wherein at least 80% by weight of a material forming the first layer is the same compound or compounds as a material forming the second layer.

43. A pocket according to claim 42, wherein each compound of said at least 80% by weight belongs to the same chemical family, chosen from one of the following chemical families: the family of polyolefins, the family of polyvinyl chlorides and derivatives, the family of styrenes, the family of polyoxymethylenes, the family of polyamides, the family of saturated polyesters, the family of polycarbonates, the family of sulfonic polymers, the family of polyphenylene oxides, the family of cellulose polymers, and the family of polyurethanes.

44. A pocket according to claim 38, wherein the two layers are made of the same compound.

45. A pocket according to claim 44, wherein the compound belongs to the polyamides family.

46. A pocket according to claim 45, wherein the compound is polyamide 11.

47. A pocket according to claim 38, wherein the pocket includes said first and second layers made of at least two different materials, and wherein the first layer of the pocket is made from a compound belonging to the polyamides family, and the second layer of said pocket is made from a different compound belonging to the same polyamides family.

48. A pocket according to claim 47, wherein the first layer includes polyamide 11 and the second layer includes polyamide 6,6.

49. A pocket according to claim 38, wherein one of the layers forming the pocket includes a filler which imparts color to said layer.

50. A pocket according to claim 38, wherein one of the layers forming the pocket includes a filler which renders said layer opaque.

51. A pocket according to claim 38, wherein the flexible pocket forms a wall having a thickness between one-tenth and three-tenths of a millimeter.

52. A pocket according to claim 38, wherein the pocket is formed by an extrusion blow molding process.

53. A pocket according to claim 38, wherein said pocket contains a cosmetic product.

54. A pocket according to claim 38, wherein each of the layers each contains at least 80% by weight of the same compound.

55. A pocket according to claim 54, wherein each compound forming one of the layers belongs to the same chemical family as each compound forming another of the layers.

56. A pocket according to claim 38, wherein each compound forming one of the layers belongs to the same chemical family as each compound forming another of the layers.

57. A pocket according to claim 56, wherein each layer is formed of plural compounds.

58. A packaging device for a product, including:
a bottle; and
an internal pocket disposed inside the bottle and capable of containing the product, and wherein the pocket is freely deformable inside the bottle;
wherein the internal pocket includes plural layers made from different materials that are physically and chemically compatible with each other such that each of the layers is capable of being attached to any other layer of the pocket by direct physicochemical reaction between said materials respectively constituting each of the layers.

59. A packaging device according to claim 58, wherein the internal pocket includes at least three layers.

60. A packaging device according to claim 58, further including a cosmetic product inside of said internal pocket.

61. A packaging device for a product, including:
a bottle; and
an internal pocket disposed inside the bottle and capable of containing the product, wherein the internal pocket is freely deformable inside the bottle, and wherein the internal pocket includes at least first and second layers, and further wherein the first layer is made of a first material different from a second material constituting the second layer, wherein the first and second materials are non-adhesive and physically and chemically compatible with each other such that the first and second layers are attached to each other by direct physicochemical reaction between the material of the first layer and the material of the second layer.

62. A packaging device according to claim 61, further including a cosmetic product inside of said internal pocket.
